(19) United States
(12) Patent Application Publication
(10) Pub. No.: US 2015/0242748 A1
(43) Pub. Date: Aug. 27, 2015

(54) METHOD AND SYSTEM FOR PREDICTING FUTURE POLITICAL EVENTS USING PAYMENT TRANSACTION DATA

(71) Applicant: MasterCard International Incorporated, Purchase, NY (US)

(72) Inventors: Kenneth UNSER, Fairfield, CT (US); Serge BERNARD, Danbury, CT (US); Nikhil MALGATTI, Stamford, CT (US)

(73) Assignee: MasterCard International Incorporated, Purchase, NY (US)

(21) Appl. No.: 14/186,461

(22) Filed: Feb. 21, 2014

(51) Int. Cl. G06N 5/04

(52) U.S. Cl. CPC G06N 5/04

(57) ABSTRACT

A method for predicting the occurrence of a future political event includes: storing a plurality of event data entries, each entry including data related to a past political event including at least an event category associated with the related political event and one or more past transaction behaviors; storing a plurality of transaction data entries, each entry including data related to a payment transaction conducted in a predetermined geographic area including at least transaction data; identifying one or more current transaction behaviors based on the transaction data included in each transaction data entry; identifying a specific event data entry based on a correspondence between the identified one or more current transaction behaviors and the one or more past transaction behaviors included in the specific event data entry; and predicting an event associated with the event category included in the specific event data entry in the predetermined geographic area.

### FIELD

The present disclosure relates to the predicting of future political events, specifically the analysis of transaction data for past political events matched to current transaction data for a geographic area for prediction of the occurrence of a future political event.

### BACKGROUND

Political events, such as regime changes, elections, law changes, boycotts, protests, etc., can have a great effect on the local population and the economy, and, in some instances, may have drastic effects on other populations throughout the world. In many cases, such events may begin and gain support and popularity very quickly, leaving little time for local people, the local government, or neighboring people or entities to react. Police and other authorities sometimes employ monitoring devices (hidden microphones, cameras, telephone taps, tracking devices, computer programs that monitor social media, blogs, news outlets, etc.) to monitor certain areas or individuals who might be thought to be instigators of adverse political events, but these measures can be cumbersome, inaccurate and/or unreliable, and raise concerns regarding privacy and due process of law. As such, the present inventors believe there is a need for a technical solution to predict the future occurrence of such political events.

Political events may cause local consumers to make different purchases, such as by buying different products, buying different amounts of products, buying from different merchants, importing or exporting different goods, etc. As a result, the transaction behavior of consumers leading up to political events may be identifiable. The present inventors believe a technical solution to predicting political events can be found by using past transaction behaviors of consumers, which may be aggregated and/or anonymous models, leading up to past political events to predict future political events based on similar present transaction behaviors for consumers in a specified geographical area.

### SUMMARY

The present disclosure provides a description of systems and methods for predicting the occurrence of a future political event.

A method for predicting the occurrence of a future political event includes: storing, in an event database, a plurality of event data entries, wherein event data entries include data related to a past political event including at least an event category associated with the related political event and one or more past transaction behaviors; storing, in a transaction database, a plurality of current transaction data entries, wherein transaction data entries include data related to current payment transactions conducted in a predetermined geographic area including at least transaction data; identifying, by a processing device, one or more current transaction behaviors based on the transaction data included in transaction data entries of the plurality of current transaction data entries; identifying, by the processing device, at least one specific event data entry based on a correspondence between the identified one or more current transaction behaviors and the one or more past transaction behaviors included in the at least one specific event data entry; and predicting, by the processing device, an event associated with the event category included in the specific event data entry in the predetermined geographic area. The prediction may also provide an indication of a determined probability of one or more predicted probable events.

A system for predicting the occurrence of a future political event includes an event database, a transaction database, and a processing device. The event database is configured to store a plurality of event data entries, wherein event data entries includes data related to a past political event including at least an event category associated with the related political event and one or more past transaction behaviors. The transaction database is configured to store a plurality of transaction data entries, wherein current transaction data entries include data related to current payment transactions conducted in a predetermined geographic area including at least transaction data. The processing device is configured to: identify one or more current transaction behaviors based on the transaction data included in the transaction data entries of the plurality of current transaction data entries; identify at least one specific event data entry based on a correspondence between the identified one or more current transaction behaviors and the one or more past transaction behaviors included in the at least one specific event data entry; and predict an event associated with the event category included in the specific event data entry in the predetermined geographic area.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for predicting the occurrence of a future political event in accordance with exemplary embodiments.

FIG. 2 is a block diagram illustrating the processing server of FIG. 1 for the predicting of future political events based on transaction behavior in accordance with exemplary embodiments.

FIG. 3 is a flow diagram illustrating a process for predicting future political events using the processing server of FIG. 2 in accordance with exemplary embodiments.

FIG. 4 is a diagram illustrating the predicting of a future political event based on transaction behaviors for past political events in accordance with exemplary embodiments.

FIG. 5 is a flow chart illustrating an exemplary method for predicting the occurrence of a future political event in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

### System for Predicting Future Political Events

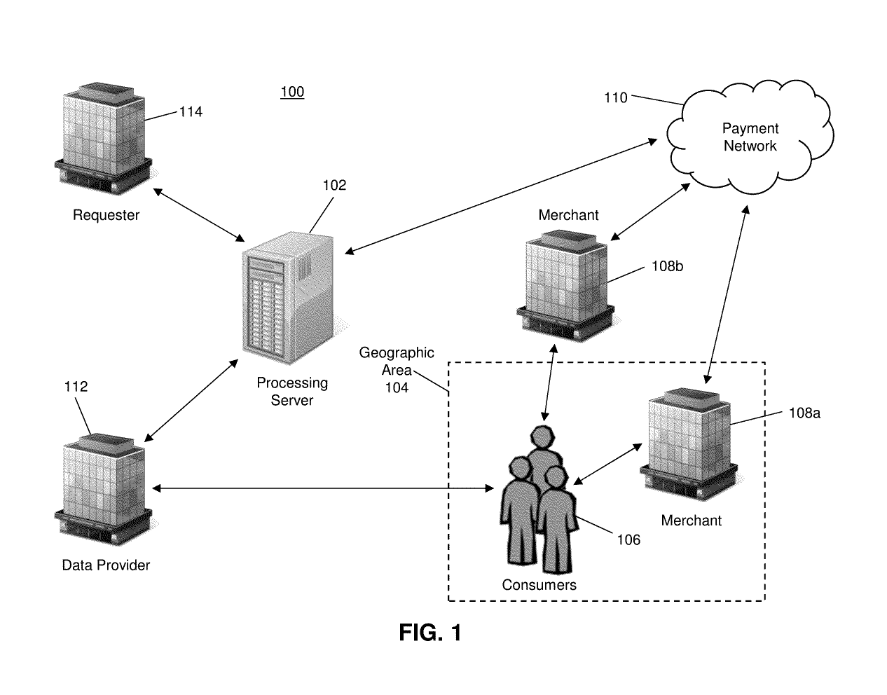

FIG. 1 illustrates a system 100 for the prediction of future political events based on transaction data.

The system 100 may include a processing server 102. The processing server 102, discussed in more detail below, may be configured to predict future political events for a predetermined geographic area 104 based on current transaction behaviors using methods and systems discussed herein. Current transaction behaviors can be in the form of a model, statistical data, or correlation of transaction data. For example, if a military coup occurred in a particular country, current transaction data for the days or weeks leading up to the coup might include notable increases in the sale of transportation services for leaving the country or its capital, increases in the sale of medical supplies, weapons, and protective and/or survival gear as members of the local population become nervous due to rising political tensions, etc. That pattern can form a statistical model (e.g., percentage increases in merchant category sales and/or SKU codes if captured in transaction data), or the transaction data form a template of data, etc. or other means of matching data sets that are apparent to those skilled in the art. If the same or similar transaction behavior is seen in the same or a different country, then a prediction can be made, and a probability assigned based on the similarity of the current and past transaction behaviors. For instance, depending on circumstances, some of these types of transactions might be due to a predicted imposition of martial law or some type of economic sanctions (e.g., outbound travel and survival supplies) but others (e.g., lacking a strong uptick in the purchase of weapons) may indicate that a coup is more likely than the imposition of martial law, but either is possible.

The area 104 may be a town or city, state or country or regions, or other demarcations of geographic areas in which a plurality of consumers 106 exist. The areas 104 can be preselected, commonly known, or dynamically assigned (e.g., by drawing an area on an electronic map and identifying transactions from point of sale locations within the designated area). In embodiments where past transactions are stored or are available, past transaction behaviors can be dynamically generated or reformulated as a result of new areas 104 being designated. The consumers 106 may conduct payment transactions with one or more merchants 108. The merchants 108 may be included in the area 104, or may be external to the area 104, such as merchant 108a located in the area 104 and merchant 108b not located in the area 104, but transactions associated with the area 104 (e.g., by shipping address, etc.).

Payment transactions involving the consumers 106 and merchants 108 may be processed by a payment network 110 using methods and systems that will be apparent to persons having skill in the relevant art. The payment network 110 may transmit transaction data for each transaction involving a consumer 106 or merchant 108 located in the area 104 to the processing server 102. The processing server 102 may store all of the transaction data in a transaction database, as discussed in more detail below.

The processing server 102 may analyze the transaction data for the payment transactions to identify transaction behavior associated with the area 104. As discussed in more detail below, the processing server 102 may then identify past transaction behaviors for past political events that correspond to the identified current transaction behavior for the area 104. Based on the correspondence with the transaction behavior for past political events, the processing server 102 may predict the occurrence of a future political event to occur associated with the area 104. For example, the current transaction behavior for the area 104 may be similar to the past transaction behaviors in the same or other areas prior to protests regarding political leaders. The processing server 102 may accordingly predict that a protest against the same or a different political leader of the area 104 may be about to occur. The degree of similarity and specificity of the data can be used to provide a rating or probability of the event occurring. Current transaction behaviors may resemble more than one past transaction behavior, thereby predicting more than one type of political event could occur as explained above, and the probabilities can be used to rank the likelihood of the possible different event scenarios.

In some instances, the processing server 102 may be configured to predict detailed information regarding the predicted event. For instance, in the above example, the processing server 102 may predict an approximate date of the start, duration and/or severity of the predicted protest, based on a timeline of events and past transaction behaviors for the past political event or events, and the transactions behaviors and timing for the area 104.

The processing server 102 may also predict additional aspects of the predicted event, such as based on data associated with the consumers 106. The data associated with the consumers 106 may be captured by a data provider 112 and provided to the processing server 102. The data may be demographics (e.g., age, gender, occupation, education, etc.) or other suitable types of data that will be apparent to persons having skill in the relevant art. In some instances, the processing server 102 may use the consumer data in the identification of past and current transaction behaviors, such as identifying past and current transaction behaviors for specific demographics of the consumers 106. In such an instance, the processing server 102 may identify more detailed current transaction behaviors, which may be used for matching with past transaction behaviors of a past political event.

In some embodiments, transactions would be continually monitored and, when current transaction behaviors sufficiently match past transaction behaviors, an alert might be generated. In still other embodiments, political events are continually predicted with probabilities associated with them, which might be zero or close to zero, and perhaps graphically shown as timelines to show trends. In still other embodiments, the processing server 102 may receive a request for a prediction from a requester 114. These embodiments might be combined, of course.

The requester 114 may be an entity that is requesting a predicting for a future political event that may occur in the area 104. In such an embodiment, the requester 114 may submit a request to the processing server 102 specifying the area 104. The processing server 102 may then request transaction data for transactions involving the consumers 106 or merchants 108a located in the area 104 from the payment network 110. The processing server 102 may receive the transaction data, and may identify current transaction behaviors and subsequently predict the occurrence of a future political event based thereon. The processing server 102 may then provide the prediction to the requester 114. In some instances, the request may include requests for predictions of additional event data, such as start dates, end dates, economic impacts, etc. In such an instances, the processing server 102 may identify the additionally requested information based on the transaction data and any additional data (e.g., received from the data provider 112) to include in the response provided to the requester 114.

The use of current transaction behaviors to predict future political events may enable the processing server 102 to predict events with accuracy and specificity due to the common behaviors of consumers leading up to political events. In addition, current transaction behaviors may be objective and based on empirical data, and thus may be more effective than other potential data sources for predicting future events, such as social media, blogs, news outlets, etc. As such, the methods and systems discussed herein may provide for accurate and effective predicting of the occurrence of future political events using transaction data either as a stand-alone method and system, or in combination with other potential data sources, such as social media, blogs, news outlets, etc. The analysis can also be augmented to include use of Conflict and Medication Event Observations (CAMEO) code or Integrated Data for Events Analysis (IDEA) codes, or any other automated coding systems that automatically code political speech, news events, etc., relating to political environments. In this way, current transaction behaviors can be synchronized with CAMEO or IDEA codes automatically generated from current output of various, selected media outlets to past transaction behavior and CAMEO or IDEA codes of past political events.

### Processing Server

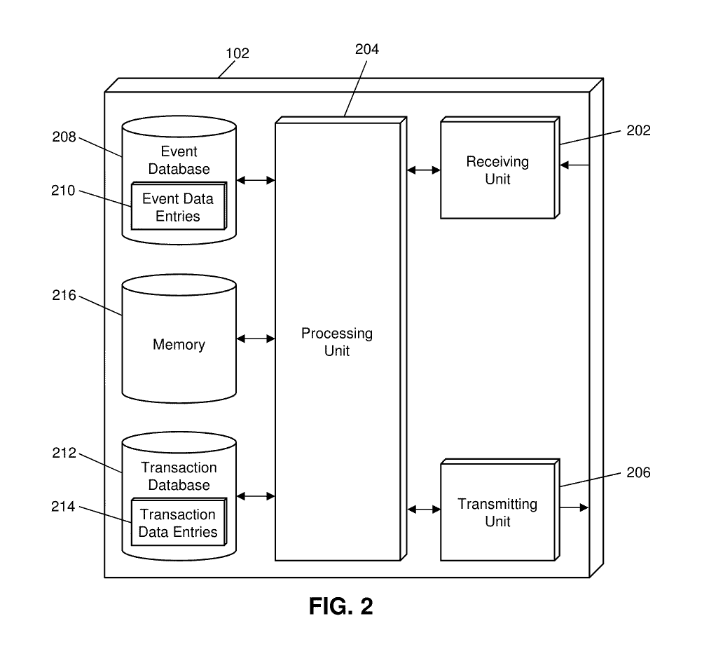

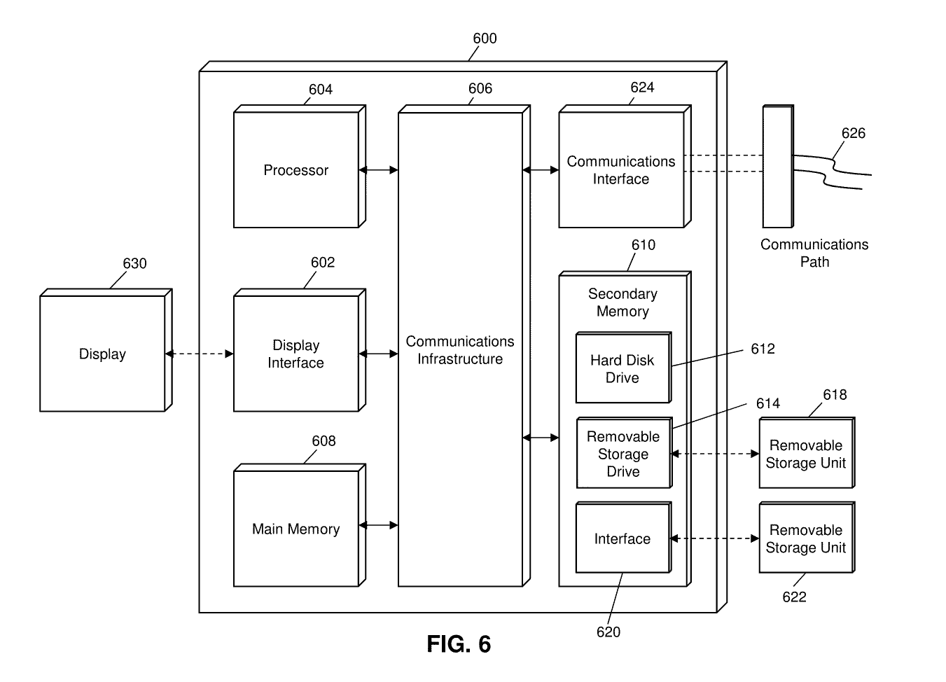

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of processing server 102 suitable for performing the functions as discussed herein. For example, the computer system 600 illustrated in FIG. 6 and discussed in more detail below may be a suitable configuration of the processing server 102.

The processing server 102 may include a receiving unit 202. The receiving unit 202 may be configured to receive requests and data over one or more networks via one or more network protocols. The receiving unit 202 may receive transaction data from the payment network 110. The transaction data may correspond to payment transactions involving consumers 106 and/or merchants 108 located in an area 104. The processing server 102 may further include a processing unit 204. The processing unit 204 may be configured to store the received transaction data in a transaction database 212 as a plurality of transaction data entries 214.

Each transaction data entry 214 may include data related to a payment transaction including at least the associated geographical area 104 and transaction data. The transaction data may include a transaction amount, transaction time and/or date, merchant data, product data, and/or any other data that may be suitable for performing the functions disclosed herein as will be apparent to persons having skill in the relevant art.

The processing server 102 may further include an event database 208. The event database 208 may include one or more event data entries 210. Each event data entry 210 may include data related to a past political event, including at least an event category associated with the past political event and one or more past transaction behaviors. The one or more past transaction behaviors may be transactions behaviors identified based on transaction data for payment transactions involving consumers 106 and/or merchants 108a included in an area 104 associated with the past political event.

In some embodiments, the one or more consumer current transaction behaviors may be identified by the processing unit 204 based on past transaction data entries 214 stored in the transaction database 212. For example, the receiving unit 202 may receive virtually all transaction data, or a subset of transaction data for a political event that has occurred, and the processing unit 204 may identify past transaction behaviors based on the received transaction data, which may be associated with the past political event and stored in a corresponding event data entry 210 in the event database 208. Current transaction behaviors, perhaps in the form of transaction models, can be generated from the transaction data entries 214. In other embodiments, the one or more past transaction behaviors may be received along with event data regarding the past political event, such as the associated event category.

The associated event category may be a category associated with the political event that may be suitable for predicting a future political event based on corresponding in past transaction behaviors for the associated past political event and current transaction behaviors identified for a predetermined area 104. In some embodiments, the event category may be a CAMEO code or IDEA codes, or any other automated coding systems that automatically code, or received manual codes, relating to political event data. The use of CAMEO codes, IDEA codes, or other political event coding systems to categorize or otherwise identify political events will be apparent to persons having skill in the relevant art.

The receiving unit 202 may be further configured to receive a request for prediction of a future political event. The request may include at least an area 104. The processing unit 204 may identify transaction data entries 214 stored in the transaction database 212 associated with the area 104 and may identify current transaction behaviors for the area 104 based on the transaction data included in each of the identified transaction data entries 214. The current transaction behaviors may be spending propensities or other behaviors for products, merchants, industries, or other suitable criteria that may be identified as analysis of the transaction behavior of consumers 106 associated with the area 104. For example, the processing unit 204 may identify an increase or decrease in the spending of consumers 106 in the area 104 for types of goods (e.g., electronics, munitions, groceries, military surplus items) or types of services (e.g., entertainment, education, military training), increase or decrease in spending with merchants 108 inside of the area 104 or outside of the area 104, travel expenses, medical and other types of supplies that might be associated with certain types of events, and combinations or patterns thereof, or other suitable behaviors.

The processing unit 204 may also be configured to identify specific event data entry 210 stored in the event database 208 based on correspondence between the identified current transaction behaviors for the area 104 and the one or more past transaction behaviors included in the specific event data entry 210. The specific event data entry 210 may be an event data entry 210 for which one or more past transaction behaviors most closely matches to the current transaction behaviors identified for the area 104. The processing unit 204 may then identify a prediction of a future political event that is associated with the same event category included in the specific event data entry 210. For example, if the specific event data entry 210 is related to a past political event having a political category of the resignation of a political leader, then the processing unit 204 may identify that the transaction behavior indicates a possible future resignation of a political leader.

In some embodiments, the processing unit 204 may be further configured to predict additional data regarding the predicted event. For example, the processing unit 204 may, based on the previously identified transaction data entries 214 and/or any additional data included in the specific event data entry 210, identify dates, impacts, descriptions, names, results, lengths, or other suitable data for the predicted event as will be apparent to persons having skill in the relevant art.

In some embodiments, the predicted event or associated event data may be identified using additional data. The additional data may be received by the receiving unit 202 and may include consumer demographic data, merchant data, merchant demographic data, or other data suitable for performing the functions as disclosed herein. The processing unit 204 may use the received additional data accordingly, such as in the identification of current transaction behaviors for the area 104 or the prediction of event data associated with a predicted future political event.

The processing server 102 may also include a transmitting unit 206. The transmitting unit 206 may be configured to transmit data over one or more networks via one or more network protocols. The transmitting unit 206 may transmit the predicted future political event, and any associated event data, in response to the request received by the receiving unit 202.

The processing server 102 may also include a memory 216. The memory 216 may be configured to store any additional data suitable for performing the functions as disclosed herein. For example, the memory 216 may store rules or algorithms for the identification of past or current transaction behaviors based on transaction data, identification of a specific event data entry 210 based on correspondence between current transaction behaviors and past transaction behaviors, prediction of a future political event, prediction of event data associated with the predicted event, etc. The memory 216 may also include program code to be executed by the processing unit 204 in order for the processing server 102 to perform the functions as disclosed herein.

### Process for Predicting a Future Political Event

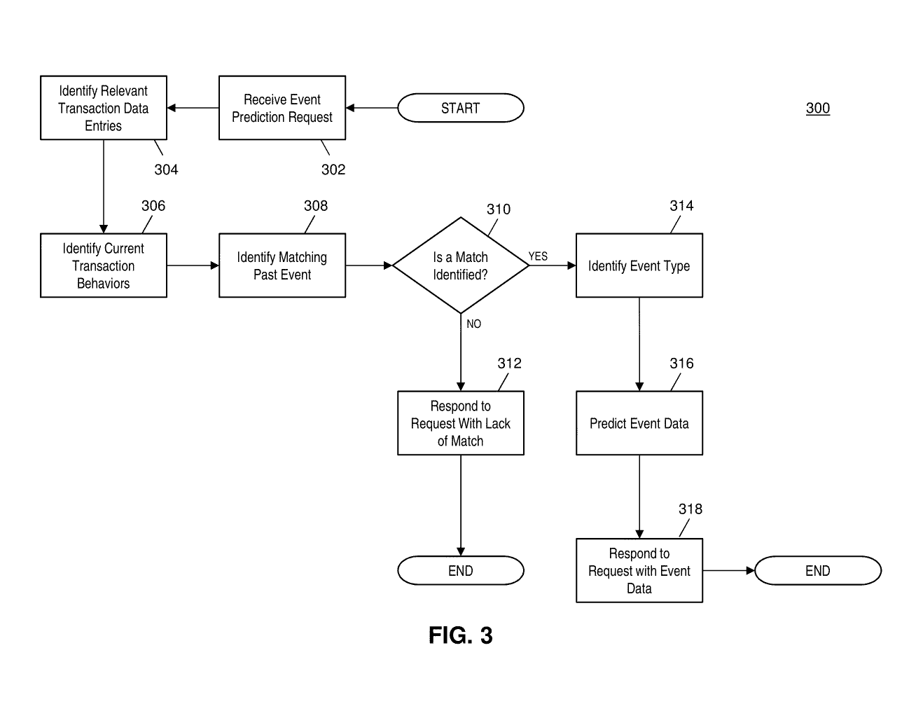

FIG. 3 illustrates a process 300 for the prediction of a future political event by the processing server 102.

In step 302, the receiving unit 202 of the processing server 102 may receive an event prediction request (e.g., from the requester 114). The event prediction request may include at least a predetermined geographic area 104 for which the prediction is requested. In some embodiments, the request may further include a predetermined period of time and/or requested event data. In step 304, the processing unit 204 of the processing server 102 may identify transaction data entries 214 that correspond to payment transactions associated with the area 104. In some instances, each of the transaction data entries 214 stored in the transaction database 212 may be associated with the area 104. In other instances, the processing unit 204 may identify those transaction data entries 214 that involve a merchant 108 or consumer 104 located in the area 104 and/or whose transaction data include a geographic location included in the area 104.

In embodiments where the request includes a predetermined period of time, each transaction data entry 214 identified by the processing unit 204 may include a transaction time and/or date included in the predetermined period of time. In other embodiments, the processing unit 204 may only identify transaction data entries 214 that include a transaction time and/or date within a predetermined period of time from a present time, such as to limit the use of older transaction data from affecting current transaction behaviors. The predetermined period of time for using transaction date to determine past or current transaction behaviors may vary based on the area 104 or other considerations as will be apparent to persons having skill in the relevant art.

In step 306, the processing unit 204 may identify current transaction behaviors for consumers 106 in the area 104 based on the transaction data included in each of the identified transaction data entries 214. In some embodiments, the current transaction behaviors may be organized based on additional consumer data that may have been received by the receiving unit 202, such as demographics data. In step 308, the processing unit 204 may identify a matching past event by identifying a specific event data entry 210 stored in the event database 208 based on a correspondence between the one or more past transaction behaviors included in the specific event data entry 210 and the identified current transaction behaviors for the area 104. In some embodiments, the correspondence may be required to be above a predetermined threshold, such as a correspondence percentage, or the correspondence percentage can be provided to give recipients of the information an indication of the probability of one or more events.

In step 310, the processing unit 204 may identify if a match to a past political event was successful. If no match was successful, such as if no specific event data entry 210 could be identified with a correspondence to the identified current transaction behaviors above the predetermined threshold, then, in step 312, the transmitting unit 206 of the processing server 102 may transmit a response to the received event prediction request indicating that a prediction may be unavailable due to the lack of a suitable match of a past political event.

If a matching past political event was identified, then, in step 314, the processing unit 204 may identify the type of political event matched to the identified current transaction behaviors based on the event category included in the identified specific event data entry 210. In step 316, the processing unit 204 may predict a future political event for the area 104 based on the identified type of political event. In embodiments where the event prediction request may include a request for additional event data, step 316 may further include the identification of the requested additional event data based on at least the transaction data included in the identified transaction data entries 214 and/or data included in the specific event data entry 210. In step 318, the transmitting unit 206 may transmit a response to the event prediction request. The response may include at least the predicted event and any additionally requested event data identified in step 316.

### Identifying a Matching Past Political Event

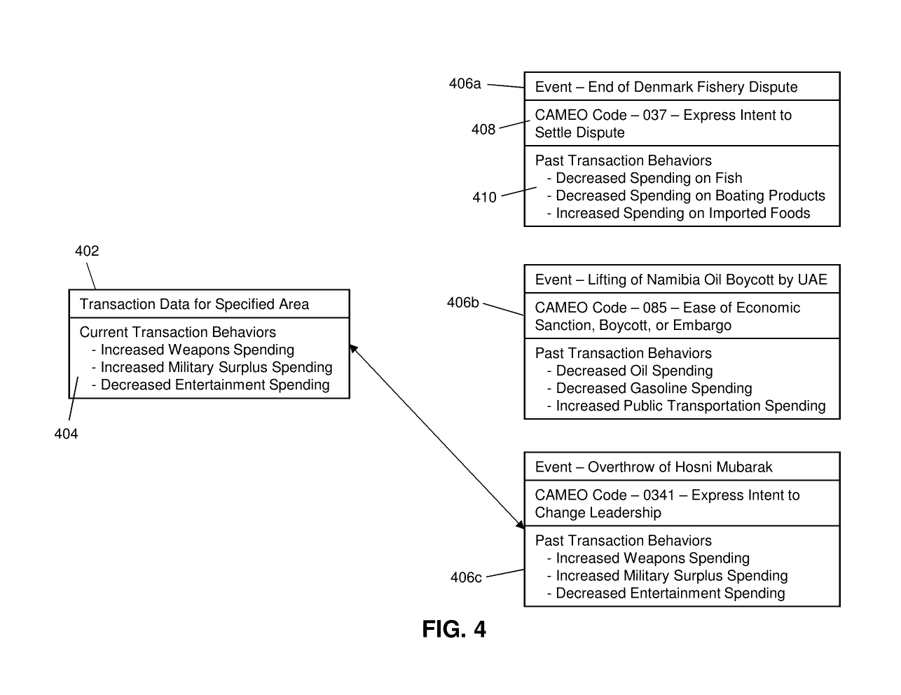

FIG. 4 is a diagram illustrating the identification of a past political event based on correspondence in current transaction behaviors based on current transaction data.

FIG. 4 includes transaction data 402. The transaction data 402 may be transaction data corresponding to payment transactions associated with the area 104, such as payment transactions involving consumers 106 and/or merchants 108 included in or associated with the area 104. The processing unit 204 may identify a plurality of current transaction behaviors 404 for the transaction data 402. In the example illustrated in FIG. 4, the processing unit 204 may identify current transaction behaviors for the area 104 to indicated increased spending on weapons and military surplus items, and decreased spending on entertainment. The behaviors may be identified, for example, based on increased or decreased revenue by corresponding merchants 108.

FIG. 4 also includes past events 406, illustrated as past events 406a, 406b, and 406c. Each past event 406 may correspond to an event data entry 210 stored in the event database 208 and may correspond to a past political event for which the processing server 102 has received and/or identified data. Each past event 4506 may include be associated with one or more event categories 408. In the example illustrated in FIG. 4, each event category 408 may be a CAMEO code and corresponding category, such as CAMEO code 037, corresponding to an Express Intent to Settle Dispute, for the past event 406a, which corresponds to the end of a fishery dispute in Denmark.

Each past event 406 may also include one or more past transaction behaviors 410. The past transaction behaviors 410 may be based on transaction data of payment transactions associated with the past event 406 and/or an area 104 associated with the past event 406 prior to a time at which the past event 406 occurred. In the example illustrated in FIG. 4, each past event 406 includes three identified past transaction behaviors associated with the corresponding event, such as decreased spending on fish and boating products and an increased spending in imported foods for past event 406a corresponding to the end of the Denmark fisheries dispute.

As discussed above, the processing unit 204 may be configured to identify a match for identified current transaction behaviors 404 with a past event 406. The match may be based on a correspondence between the identified current transaction behaviors 404 and the past transaction behaviors 410 for the past events 406. In the example illustrated in FIG. 4, the processing unit 204 may identify that past event 406c corresponds to the transaction data 402 for the area 104 as the past transaction behaviors 410 for the past event 406c directly correspond to the current transaction behaviors 404. Accordingly, the processing unit 204 may identify that the current transaction behaviors 404 for the area 104 indicate that a similar event may occur, which may correspond to the event category 408 associated with the past event 406c. In the example illustrated in FIG. 4, the processing unit 204 may accordingly predict that a change of leadership in the area 104 may occur.

### Exemplary Method for Predicting the Occurrence of a Future Political Event

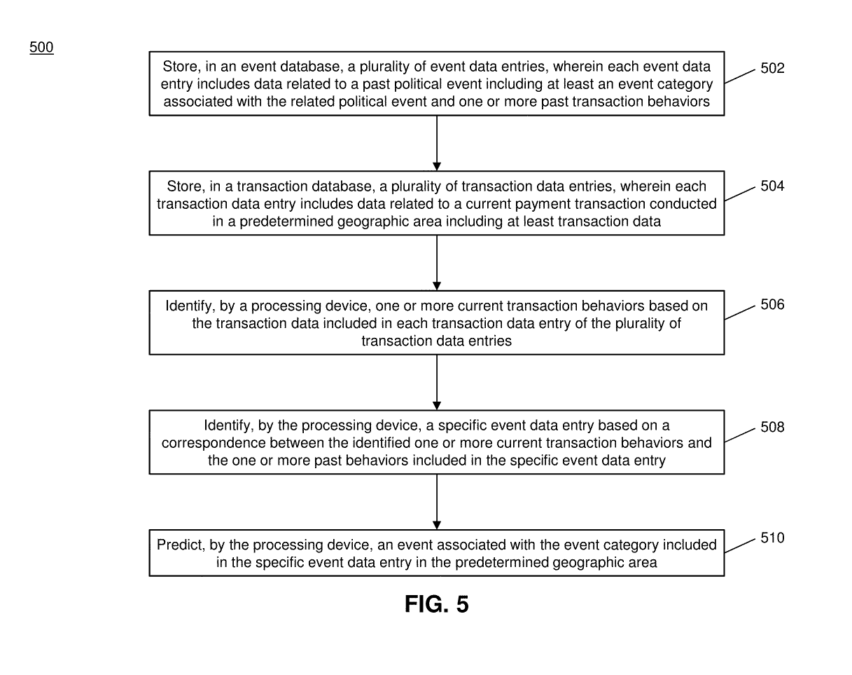

FIG. 5 illustrates a method 500 for the predicting of an occurrence of a future political event based on transaction data.

In step 502, a plurality of event data entries (e.g., event data entries 210) may be stored in an event database (e.g., the event database 208), wherein each event data entry 210 includes data related to a past political event (e.g., past event 406) including at least an event category (e.g., the event category 408) associated with the related political event and one or more past transaction behaviors (e.g., past transaction behaviors 410). In one embodiment, the event category may be a Conflict and Mediation Event Observations (CAMEO) code.

In step 504, a plurality of transaction data entries (e.g., transaction data entries 214) may be stored in a transaction database (e.g., the transaction database 212), wherein each transaction data entry 214 includes data related to a payment transaction conducted in a predetermined geographic area (e.g., area 104) including at least transaction data. In one embodiment, the transaction data includes at least one of: transaction time and/or date, product data, merchant data, transaction amount, and geographic location.

In step 506, one or more current transaction behaviors (e.g., current transaction behaviors 404) may be identified, by a processing device (e.g., the processing unit 204), based on the transaction data included in each transaction data entry 214 of the plurality of transaction data entries. In step 508, a specific event data entry 210 may be identified, by the processing device 204, based on a correspondence between the identified one or more current transaction behaviors 404 and the one or more past transaction behaviors 410 included in the specific event data entry 210.

In step 510, the processing device 204 may predict an event associated with the event category 408 included in the specific event data entry 210 in the predetermined geographic area 104. In some embodiments, each transaction data entry 214 may further include at least a transaction time and/or date, and each event data entry 210 may further include at least timing date. Predicting the event may further include predicting an occurrence date for the event based on at least the transaction time and/or date included in each transaction data entry 214 and the timing data included in the identified specific event data entry 210. In one embodiment, each event data entry 210 may further include event data, and the predicted event may be further based on at least the event data included in the specific event data entry 210. In a further embodiment, the event data may include at least one of: a time and/or date, name, description, impact, result, and length.

In some embodiments, the method 500 may further include: receiving, by a receiving device (e.g., the receiving unit 202), a request for a future event prediction, wherein the request includes at least the predetermined geographic area 104. In a further embodiment, the method 500 may even further include: transmitting, by a transmitting device (e.g., the transmitting unit 206), the predicted event in response to the received request for a future event prediction. In another further embodiment, the request for a future event prediction may further include a predetermined period of time, each of the transaction data entries 214 may further include a transaction time and/or date, and the transaction time and/or date included in each transaction data entry 214 may be within the predetermined period of time.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3 and 5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for predicting the occurrence of a future political event. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for predicting the occurrence of a future political event comprising:
storing, in an event database, a plurality of event data entries, wherein event data entries include data related to a past political event including at least an event category associated with the related political event and one or more past transaction behaviors;
storing, in a transaction database, a plurality of current transaction data entries, wherein transaction data entries include data related to current payment transactions conducted in a predetermined geographic area including at least transaction data;
identifying, by a processing device, one or more current transaction behaviors based on the transaction data included in transaction data entries of the plurality of current transaction data entries;
identifying, by the processing device, at least one specific event data entry based on a correspondence between the identified one or more current transaction behaviors and the one or more past transaction behaviors included in the at least one specific event data entry; and
predicting, by the processing device, an event associated with the event category included in the specific event data entry in the predetermined geographic area.

2. The method of claim 1, wherein the transaction data includes at least one of: transaction time and/or date, product data, merchant data, transaction amount, and geographic location.

3. The method of claim 1, wherein
each transaction data entry further includes at least a transaction time and/or date,
each event data entry further includes at least timing data, and
predicting the event includes predicting an occurrence date for the event based on at least the transaction time and/or date included in each transaction data entry and the timing data included in the identified specific event data entry.

4. The method of claim 1, wherein the event category is a Conflict and Mediation Event Observations code.

5. The method of claim 1, wherein
each event data entry further includes event data, and
the predicted event is based on at least the event data included in the specific event data entry.

6. The method of claim 5, wherein the event data includes at least one of: a time and/or date, name, description, impact, result, and length.

7. The method of claim 1, further comprising:
receiving, by a receiving device, a request for a future event prediction, wherein the request includes at least the predetermined geographic area.

8. The method of claim 7, further comprising:
transmitting, by a transmitting device, the predicted event in response to the received request for a future event prediction.

9. The method of claim 7, wherein
the request for a future event prediction further includes a predetermined period of time,
each of the transaction data entries further includes a transaction time and/or date, and
the transaction time and/or date included in each transaction data entry is within the predetermined period of time.

10. A system for predicting the occurrence of a future political event comprises:
an event database configured to store a plurality of event data entries, wherein event data entries includes data related to a past political event including at least an event category associated with the related political event and one or more past transaction behaviors;
a transaction database configured to store a plurality of transaction data entries, wherein current transaction data entries include data related to current payment transactions conducted in a predetermined geographic area including at least transaction data;
a processing device configured to:
identify one or more current transaction behaviors based on the transaction data included in the transaction data entries of the plurality of current transaction data entries;
identify at least one specific event data entry based on a correspondence between the identified one or more current transaction behaviors and the one or more past transaction behaviors included in the at least one specific event data entry; and
predict an event associated with the event category included in the specific event data entry in the predetermined geographic area.

11. The system of claim 10, wherein the transaction data includes at least one of: transaction time and/or date, product data, merchant data, transaction amount, and geographic location.

12. The system of claim 10, wherein
each transaction data entry further includes at least a transaction time and/or date,
each event data entry further includes at least timing data, and
predicting the event includes predicting an occurrence date for the event based on at least the transaction time and/or date included in each transaction data entry and the timing data included in the identified specific event data entry.

13. The system of claim 10, wherein the event category is a Conflict and Mediation Event Observations code.

14. The system of claim 10, wherein
each event data entry further includes event data, and
the predicted event is based on at least the event data included in the specific event data entry.

15. The system of claim 14, wherein the event data includes at least one of: a time and/or date, name, description, impact, result, and length.

16. The system of claim 10, further comprising:
a receiving device configured to receive a request for a future event prediction, wherein the request includes at least the predetermined geographic area.

17. The system of claim 16, further comprising:
a transmitting device configured to transmit the predicted event in response to the received request for a future event prediction.

18. The system of claim 16, wherein
the request for a future event prediction further includes a predetermined period of time,
each of the transaction data entries further includes a transaction time and/or date, and
the transaction time and/or date included in each transaction data entry is within the predetermined period of time.
